(19) United States
(12) Patent Application Publication
(10) Pub. No.: US 2021/0388712 A1
(43) Pub. Date: Dec. 16, 2021

(54) METHODS OF MONITORING A GEOMETRIC PROPERTY OF A HYDRAULIC FRACTURE WITHIN A SUBSURFACE REGION, WELLS THAT PERFORM THE METHODS, AND STORAGE MEDIA THAT DIRECT COMPUTING DEVICES TO PERFORM THE METHODS

(71) Applicant: ExxonMobil Upstream Research Company, Spring, TX (US)

(72) Inventors: YUEMING LIANG, SUGAR LAND, TX (US); PEEYUSH BHARGAVA, THE WOODLANDS, TX (US); KYLE GUICE, HOUSTON, TX (US)

(21) Appl. No.: 17/228,779

(22) Filed: Apr. 13, 2021

Related U.S. Application Data
(60) Provisional application No. 63/037,817, filed on Jun. 11, 2020.
(60) Provisional application No. 63/111,958, filed on Nov. 10, 2020.

(51) Int. Cl. E21B 47/002; E21B 47/135; E21B 47/007

(52) U.S. Cl. CPC E21B 47/0025; E21B 43/26; E21B 47/007; E21B 47/135

(57) ABSTRACT

Methods of monitoring a geometric property of a hydraulic fracture within a subsurface region, wells that perform the methods, and storage media that direct computing devices to perform the methods provided. The methods include repeatedly measuring, at a plurality of measurement times, fiber strain as a function of position along a length of an optical fiber. The optical fiber is positioned within a wellbore that extends within a subsurface region and the repeatedly measuring is performed during a change in the geometric property of the hydraulic fracture. For a given measurement time of the plurality of measurement times, the methods also include differentiating the fiber strain as the function of position to generate a strain differential as a function of position along the length of the optical fiber. The methods further include determining the geometric property of the hydraulic fracture based, at least in part, on the strain differential.

### CROSS-REFERENCE TO RELATED APPLICATIONS

This application claims the benefit of U.S. Provisional Application No. 63/037,817, filed Jun. 11, 2020, and U.S. Provisional Application No. 63/111,958, filed Nov. 10, 2020, the disclosures of which are herein incorporated by reference in their entireties.

### FIELD OF THE INVENTION

The present disclosure relates generally to methods of monitoring a geometric property of a hydraulic fracture within a subsurface region, to wells that perform the methods, and to storage media that direct computing devices to perform the methods.

### BACKGROUND OF THE INVENTION

Hydraulic fracturing may be utilized to stimulate low-permeability hydrocarbon reservoirs. Hydraulic fracturing is utilized to create a plurality of fractures within the reservoirs, thereby increasing fluid permeability of the reservoirs and/or permitting hydrocarbon fluids to flow into a wellbore and subsequently to be produced from the hydrocarbon reservoirs. The geometry, dimensions, and/or extent of the hydraulic fractures that are associated with a given hydrocarbon well have a significant impact on the production characteristics of the hydrocarbon well. With this in mind, knowledge of the geometry, dimensions, and/or extent of the hydraulic fractures may guide completion stage and/or well spacing, may help to mitigate environmental concerns, and/or may be utilized to improve the accuracy of numeric models of hydrocarbon wells. However, hydraulic fractures generally are thousands, if not tens of thousands, of feet below the surface. Thus, their geometric properties cannot be directly and effectively measured. Thus, there exists a need for improved methods of monitoring a geometric property of a hydraulic fracture within a subsurface region, for improved hydrocarbon wells that perform the methods, and/or for storage media that direct computing devices to perform the methods.

### SUMMARY OF THE INVENTION

Methods of monitoring a geometric property of a hydraulic fracture within a subsurface region, wells that perform the methods, and storage media that direct computing devices to perform the methods. The methods include repeatedly measuring, at a plurality of measurement times, fiber strain as a function of position along a length of an optical fiber. The optical fiber is positioned within a wellbore that extends within a subsurface region, and the repeatedly measuring is performed during a change in the geometric property of the hydraulic fracture. For a given measurement time of the plurality of measurement times, the methods also include differentiating the fiber strain as the function of position to generate a strain differential as a function of position along the length of the optical fiber. The methods further include determining the geometric property of the hydraulic fracture based, at least in part, on the strain differential.

The hydrocarbon wells include a wellbore that extends within a subsurface region and an optical fiber that extends within the wellbore. The hydrocarbon wells also include a controller programmed to monitor a geometric property of a hydraulic fracture within the subsurface region by performing the methods.

The storage media include non-transitory computer-readable storage media. The storage media includes computer-executable instructions that, when executed, direct a computing device to perform the methods.

### BRIEF DESCRIPTION OF THE DRAWINGS

FIG. 1 is a schematic illustration of examples of a well that may be utilized with methods, according to the present disclosure.

FIG. 2 is a schematic illustration of a plurality of wells that may be utilized with methods, according to the present disclosure.

FIG. 3 is a schematic illustration of three examples of fracture formation within a horizontal well, according to the present disclosure.

FIG. 4 is a schematic illustration of examples of strain data obtained from the wells of FIG. 3.

FIG. 5 is a schematic illustration of strain derivative data obtained from the strain data of FIG. 4.

FIG. 6 is a schematic illustration of an example of a geometry that may be utilized to determine a strain field around a plane strain fracture.

FIG. 7 is a schematic illustration of examples of strain data and strain derivative data that may be obtained at varying distances between a fracture and a monitor well, according to the present disclosure.

FIG. 8 is an example of families of type curves that may be utilized with methods, according to the present disclosure.

FIG. 9 is an example of strain data as a function of depth that may be utilized with methods, according to the present disclosure.

FIG. 10 is an example of strain relaxation at various times that may be observed utilizing methods, according to the present disclosure.

FIG. 11 is an illustration of examples of strain data and strain derivative data that may be obtained from a horizontal fiber and/or may be utilized with methods, according to the present disclosure.

FIG. 12 is an illustration of an example of fracture height as a function of distance between peak strain derivative to a fracture, according to the present disclosure.

FIG. 13 is an illustration of examples of strain observed within different fracture stages.

FIG. 14 is a flowchart depicting examples of methods of monitoring a geometric property of a hydraulic fracture within a subsurface region, according to the present disclosure.

### DETAILED DESCRIPTION OF THE INVENTION

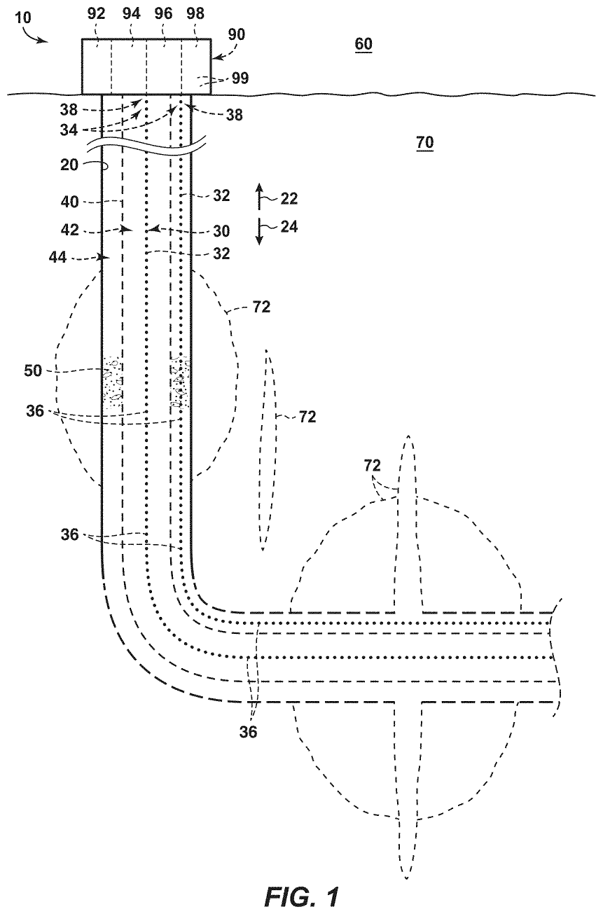

FIGS. 1-14 collectively provide examples of wells 10, of methods 100, and of data and/or analyses that may be obtained from and/or utilized with methods 100, according to the present disclosure. Elements that serve a similar, or at least substantially similar, purpose are labeled with like numbers in each of FIGS. 1-14, and these elements may not be discussed in detail herein with reference to each of FIGS. 1-14. Similarly, all elements may not be labeled in each of FIGS. 1-14, but reference numerals associated therewith may be utilized herein for consistency. Elements, components, and/or features that are discussed herein with reference to one or more of FIGS. 1-14 may be included in and/or utilized with any of FIGS. 1-14 without departing from the scope of the present disclosure.

In general, elements that are likely to be included in a particular embodiment are illustrated in solid lines, while elements that are optional are illustrated in dashed lines. However, elements that are shown in solid lines may not be essential to all embodiments and, in some embodiments, may be omitted without departing from the scope of the present disclosure.

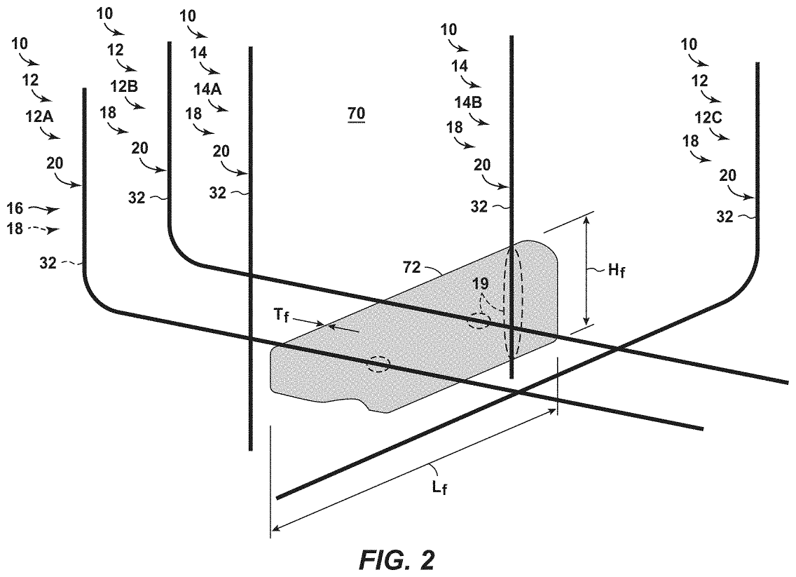

FIG. 1 is a schematic illustration of examples of a well 10 that may be utilized with methods 100, according to the present disclosure. FIG. 2 is a schematic illustration of a plurality of wells 10 that may be utilized with methods 100. FIG. 1 is a more detailed illustration of examples of structures that may be included in wells 10, while FIG. 2 is an illustration of examples of relative orientations and/or configurations for wells 10. With this in mind, any of the structures, functions, and/or features that are illustrated herein with reference to wells 10 of FIG. 1 may be included in any well 10 of FIG. 2 without departing from the scope of the present disclosure.

As perhaps best illustrated in FIG. 1, wells 10 include a wellbore 20 that extends within a subsurface region 70. Wellbore 20 also may be referred to herein as extending between a surface region 60 and subsurface region 70. Wells 10 also include an optical fiber 32, which extends and/or is positioned within wellbore 20, and a controller 90. Controller 90 is programed to monitor a geometric property of a hydraulic fracture 72 that extends within subsurface region 70, such as by performing methods 100, which are discussed in more detail here. As discussed in more detail herein, examples of the geometric property of the hydraulic fracture include a height of the fracture, a length of the fracture, and/or a thickness of the fracture.

In some examples, subsurface region 70 may include a hydrocarbon and/or a hydrocarbon reservoir. In such examples, wells 10 also may be referred to herein as hydrocarbon wells 10.

When wells 10 are utilized to monitor one or more geometric properties of hydraulic fractures 72, controller 90 may initiate, regulate, and/or control measurement of fiber strain within optical fiber 32. This fiber strain may be correlated to, may be utilized to determine, and/or may be utilized to calculate the geometric properties of the hydraulic fracture, such as via methods 100, which are discussed in more detail herein.

Controller 90 may include and/or be any suitable structure that may permit and/or facilitate initiation, regulation, and/or control of measurement of fiber strain within the optical fiber. As examples, controller 90 may include an optical signal generator 92, an optical signal receiver 94, and/or an optical signal analyzer 96. Optical signal generator 92 may be configured to generate an optical signal and/or to provide the optical signal to an initiation location 34, such as an uphole end, of optical fiber 32. The optical signal then may be conveyed away from the initiation location, in a downhole direction 24, and/or along a length of the optical fiber and may be scattered at a plurality of distributed sensing locations 36 that are spaced apart along the length of the optical fiber. A respective scattered fraction of the optical signal, which is scattered at each distributed sensing location of the plurality of distributed sensing locations, then may be conveyed along the length of the optical fiber, in an uphole direction 22, and/or toward the initiation location and may be detected, with optical signal receiver 94, at a detection location 38 of the optical fiber. Optical signal receiver 94 then may convey information regarding the respective scattered fraction of the optical signal to optical signal analyzer 96, which may analyze and/or quantify the respective scattered fraction of the optical signal.

The above-described process may be repeated a plurality of times, or even continuously, during a change in the geometric property of hydraulic fracture 72, such as may be observed before, during, and/or after hydraulic fracturing of subsurface region 70. The change in the geometric property of the hydraulic fracture may cause deformation of the optical fiber, which may cause strain within the optical fiber. This strain within the optical fiber may be measured, detected, and/or quantified via changes in the respective scattered fraction of the optical signal that is scattered at each distributed sensing location, thereby permitting and/or facilitating generation of information regarding strain in the optical fiber both as a function of position along the length of the optical fiber and as a function of time during the change in the geometric property of the hydraulic fracture. This strain in the optical fiber then may be utilized to determine and/or to estimate the geometric property of the hydraulic fracture.

As illustrated in dashed lines in FIG. 1, well 10 also may include a downhole tubular 40, such as a casing string. Downhole tubular 40, when present, may extend within wellbore 20 and may define, or at least partially bound, a tubular conduit 42. In such a configuration, wellbore 20 and downhole tubular 40 together may define, or at least partially bound, an annular space 44. Also in such a configuration, optical fiber 32 may extend within tubular conduit 42 and/or within annular space 44, as illustrated.

In some examples of well 10, optical fiber 32 may be rigidly and/or operatively attached to wellbore 20 and/or to downhole tubular 40. As an example, cement 50, which also may be referred to herein as hardened cement 50, may be positioned within annular space 44, and optical fiber 32 may extend within the cement. As another example, optical fiber 32 may be attached or otherwise secured, tethered, or coupled to an internal and/or to an external surface of downhole tubular 40 at a plurality of locations, or even continuously, along the length of the optical fiber. The presence of the attachment between the optical fiber and wellbore 20 and/or downhole tubular 40 may create a strong physical attachment between the optical fiber and strata that extends within subsurface region 70, thereby increasing a sensitivity of the optical fiber to changes in the geometric property of the fracture.

In some examples, optical fiber 32 may be permanently installed and/or positioned within wellbore 20. In some examples, optical fiber 32 may form a portion of a downhole assembly 30, which may be temporarily and/or selectively positioned within tubular conduit 42. In some such examples, downhole assembly 30 may be configured to selectively and operatively couple the optical fiber to the inner surface of the downhole tubular, such as via any suitable attachment mechanism, clip, clasp, and/or magnetic force.

Controller 90 may include and/or be any suitable structure, device, and/or devices that may be adapted, configured, designed, constructed, and/or programmed to perform the functions discussed herein. As examples, controller 90 may include one or more of an electronic controller, a dedicated controller, a special-purpose controller, a personal computer, a special-purpose computer, a display device, a logic device, a memory device, and/or a memory device having computer-readable storage media.

Additionally or alternatively, controller 90 may include or be at least one, or even be a plurality of separate and/or distinct, computing devices 98. For example, one computing device 98 may be utilized to generate the optical signal and/or to receive the respective scattered fraction of the optical signal, and another computing device may be utilized to analyze the respective scattered fraction of the optical signal and/or to monitor and/or to determine the geometric property of the hydraulic fracture.

The computer-readable storage media, when present, also may be referred to herein as non-transitory computer readable storage media 99. This non-transitory computer readable storage media may include, define, house, and/or store computer-executable instructions, programs, and/or code; and these computer-executable instructions may direct well 10 and/or controller 90 thereof to perform any suitable portion, or subset, of methods 100, which are discussed in more detail herein. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

In some examples, controller 90 may be programmed to initiate measurement of fiber strain, such as utilizing optical fiber 32. In some examples, controller 90 may be programmed to estimate a strain proportionality constant that correlates strain experienced by the subsurface region, or at a specific location within the subsurface region, to fiber strain.

In some examples, the controller may be programmed to estimate a fracture uniformity of a plurality of fractures that extends within the subsurface region. In some such examples, the estimate of fracture uniformity may be based, at least in part, on fiber strain as a function of position along the length of the optical fiber.

In some examples, the controller may be programmed to generate fiber strain as the function of position along the length of the optical fiber at a plurality of distinct times. In some such examples, the plurality of distinct times may be, or may be at least partially, subsequent to pressurization of the wellbore with a pressurizing fluid. As used herein, the phrase, “fiber strain as the function of position” may include and/or be any suitable indication of strain experienced by the optical fiber during any suitable, or relevant, timeframe. In some examples, the fiber strain as the function of position may include and/or be an absolute strain experienced by the optical fiber. In some examples, the fiber strain as the function of position may include and/or be a strain change within the optical fiber, such as may be experienced by the optical fiber over a selected time interval, such as between a first time and a second time.

In some examples, the controller may be programmed to estimate a leak-off rate of the pressurizing fluid into the subsurface region. In some such examples, the estimate of the leak-off rate may be based, at least in part, on fiber strain as the function of position at the plurality of distinct times subsequent to pressurization of the wellbore with the pressurizing fluid.

In some examples, the controller may be programmed to estimate a volume fraction of the hydraulic fracture. In some such examples, the estimate of the volume fraction of the hydraulic fracture may be based, at least in part, on the geometric property of the hydraulic fracture, on a volume of the pressurizing fluid provided to pressurize the wellbore, and/or the leak-off rate. In some examples, the controller may be programmed to correlate a fracture relaxation rate of the hydraulic fracture to the fiber strain as the function of position at the plurality of distinct times subsequent to pressurization of the wellbore with the pressurizing fluid.

Turning to FIG. 2, a plurality of wells 10 that extends within a subsurface region 70 are illustrated schematically. The plurality of wells 10 may include one or more horizontal, or at least partially horizontal, wells 12 and/or a plurality of vertical, or at least substantially vertical, wells, 14. Wells 10 additionally or alternatively may be referred to herein as including horizontal and/or vertical well regions. At least one well 10 is a treatment well 16, and a hydraulic fracture 72 extends from the treatment well. Stated another way, and prior to the configuration that is illustrated in FIG. 2, the treatment well was pressurized with a pressurizing fluid to form and/or define the hydraulic fracture within the subsurface region.

In some examples of wells 10 and/or of methods 100, which are disclosed herein, treatment well 16 may include an optical fiber 32. In some such examples, the same wellbore 20, i.e., the wellbore of treatment well 16, may be utilized to both form the hydraulic fracture and also to monitor the geometric property of the hydraulic fracture. However, this is not required to all embodiments and wells according to the present disclosure.

As an example, one or more monitor wells 18 also may extend within the subsurface region. Monitor wells 18 additionally or alternatively may include corresponding optical fibers 32 and may be utilized to monitor the geometric property of the hydraulic fracture. In some examples, and as illustrated by the horizontal well 12B and vertical well 14B of FIG. 2, at least a region 19 of the monitor well may extend within and/or through the hydraulic fracture. Additionally or alternatively, and as illustrated by the horizontal well 12C and the vertical well 14A of FIG. 2, wellbores 20 of monitor wells 18 may be spaced apart and/or distinct from the hydraulic fracture. As discussed in more detail herein, the wells and methods, according to the present disclosure, may be configured to monitor the geometric property of the hydraulic fracture for any and/or all of these configurations.

Data obtained from wells 10 and/or from utilizing methods 100 may be interpreted differently depending upon a relative orientation between the treatment well and the monitor well, or the region of the monitor well within strain measurements are performed. As an example, vertical wells 14 and/or vertical regions of wells 10 extend along a height of hydraulic fracture 72. Thus, strain, which is caused by a change in a geometric property of hydraulic fracture 72, within optical fibers 32 that extend within vertical wells 14 and/or within vertical regions of wells 10 may be utilized to infer information regarding a height, Hf, of the fracture.

As another example, horizontal wells 12 may extend along a length of the fracture, as illustrated by the horizontal well 12C that is illustrated in FIG. 2. Thus, strain, which is caused by the change in the geometric property of hydraulic fracture 72, within optical fibers 32 that extend within such horizontal wells 12 and/or within horizontal regions of wells 10 may be utilized to infer information regarding a length, Lf, of the fracture.

As yet another example, horizontal wells 12 may extend through the fracture, as illustrated by horizontal wells 12A and 12B that are illustrated in FIG. 2. Thus, strain, which is caused by the change in the geometric property of hydraulic fracture 72, within optical fibers 32 that extend within such horizontal wells 12 and/or within horizontal regions of wells 10 may be utilized to infer information regarding a thickness, T_{f}, of the fracture.

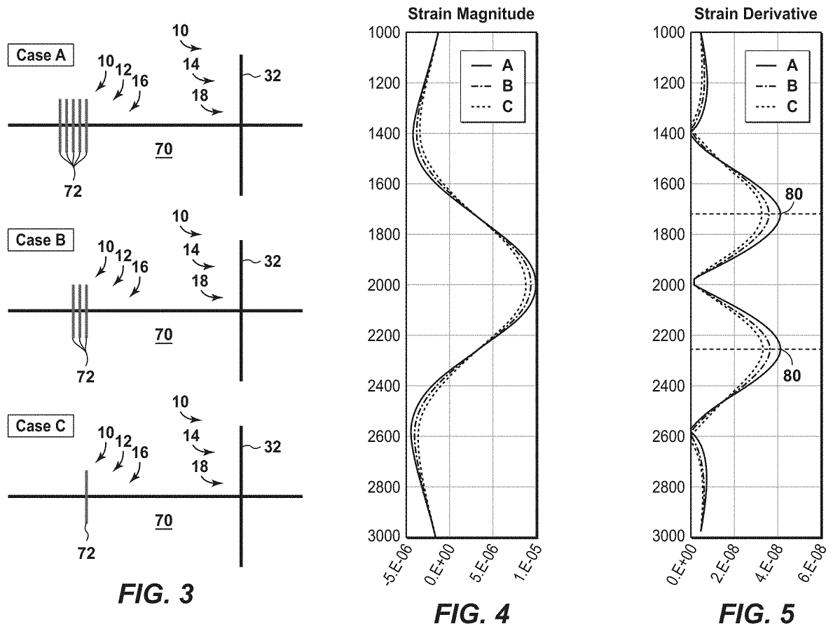

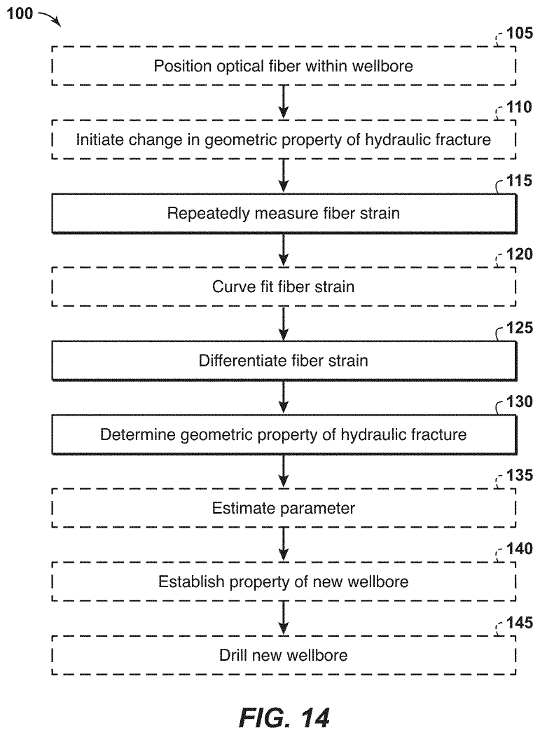

FIGS. 3-13, and the associated discussion, illustrate examples of analyses that may be performed for various situations, and for various monitor well configurations, to estimate one or more geometric properties of hydraulic fractures 72. These analyses are introduced here and referenced, where appropriate, during the discussions of methods 100, which are discussed herein with reference to FIG. 14.

FIG. 3 is a schematic illustration of three examples of fracture formation within a horizontal treatment well, as monitored by a vertical monitor well according to the present disclosure. FIG. 4 is a schematic illustration of examples of strain data obtained from the wells of FIG. 3, and FIG. 5 is a schematic illustration of strain derivative data obtained from the strain data of FIG. 4.

FIG. 3 illustrates three cases, namely, Case A, Case B, and Case C. All three cases include a vertical well 14 that is utilized as a monitor well 18 and a horizontal well 12 that is utilized as a treatment well 16. In the example of Case A, treatment well 16 includes 5 fractures extending therefrom. In the example of Case B, treatment well 16 includes 3 fractures extending therefrom. In the example of Case C, treatment well 16 includes 1 fracture extending therefrom. Hydraulic fractures 72 have similar heights for Cases A, B, and C.

FIG. 4 illustrates a strain magnitude as a function of position along the length of an optical fiber 32 that extends within monitor wells 18 of FIG. 3. The strain magnitude may be determined utilizing methods 100 that are discussed in more detail herein. FIG. 4 illustrates that, for at least substantially equal heights of hydraulic fractures 72, the strain magnitude measured by monitor wells 18 is similar in shape regardless of the number of fractures.

FIG. 5 illustrates a strain derivative of the strain magnitude. More specifically, FIG. 5 is a derivative with respect to position along the length of the optical fiber of the strain magnitude data that is illustrated in FIG. 4. FIG. 5 illustrates that, for each of the configurations illustrated in FIG. 3, the strain derivative data exhibits two peaks 80. A relative location of, or a distance between, peaks 80 may be correlated and/or related to the height of hydraulic fractures 72 utilizing methods 100 that are discussed in more detail herein. Stated another way, FIGS. 3-5 illustrate that, for a specific well configuration, namely, a horizontal treatment well 16 that is monitored by a vertical monitor well 18, at least one geometric property of hydraulic fractures 72, namely, the height of the fractures, may be monitored and/or quantified by measuring fiber strain within optical fiber 32 that extends within the vertical monitor well.

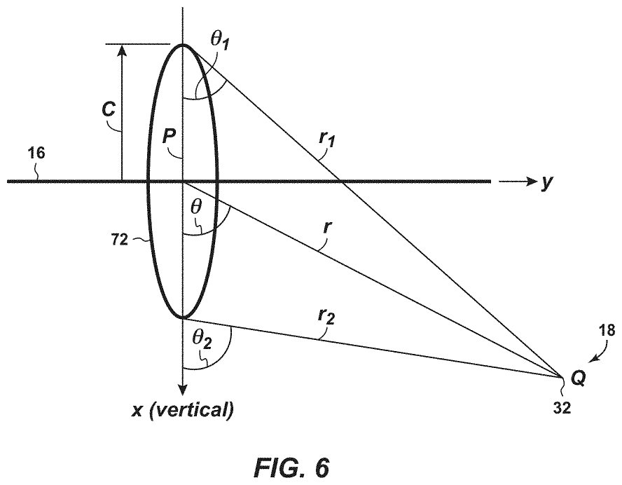

When the monitor well is separate, distinct, and/or spaced apart from the treatment well, a distance and/or a relative orientation between the monitor well and the treatment well may impact the strain that is experienced and/or measured by the optical fiber. In some examples, it may be desirable to accurately calculate and/or to determine the geometric property of the hydraulic fracture for such configurations. With this in mind, FIG. 6 illustrates an example of an analysis via which the strain field around a long hydraulic fracture 72 that extends from a horizontal treatment well 16 may be approximated with analytical equations derived under plane strain conditions. This analysis may be utilized to estimate the dimensions of hydraulic fracture 72 based upon observations made at point Q, which nominally is positioned within a monitor well 18 and is positioned along the length of an optical fiber 32 within which strain is measured. Within the system illustrated in FIG. 6, vertical strain may be approximated by Equation (1):

$${ɛ}_{v} = \frac{1 + v}{E} P \{ ( 1 - 2 v ) [ \frac{r}{\sqrt{{r}_{1} {r}_{2}}} cos ( θ - \frac{1}{2} {θ}_{1} - \frac{1}{2} {θ}_{2} ) - 1 ] - {\frac{r sin θ}{c} [ \frac{{c}^{2}}{{r}_{1} {r}_{2}} ]}^{\frac{3}{2}} sin ( \frac{3}{2} {θ}_{1} + \frac{3}{2} {θ}_{2} ) \} . \qquad ( 1 )$$

In addition, horizontal strain perpendicular to the fracture may be approximated by Equation (2):

$${ɛ}_{h} = \frac{1 + v}{E} P \{ ( 1 - 2 v ) [ \frac{r}{\sqrt{{r}_{1} {r}_{2}}} cos ( θ - \frac{1}{2} {θ}_{1} - \frac{1}{2} {θ}_{2} ) - 1 ] + {\frac{r sin θ}{c} [ \frac{{c}^{2}}{{r}_{1} {r}_{2}} ]}^{\frac{3}{2}} sin ( \frac{3}{2} {θ}_{1} + \frac{3}{2} {θ}_{2} ) \} \qquad ( 2 )$$

where εᵥ is the vertical strain, εₕ is the horizontal strain, P is the net pressure in the fracture, E is the Young's Modulus of the rock formation within which the fracture extends, v is the Poisson's Ratio of the rock formation, and the other parameters are defined within FIG. 6.

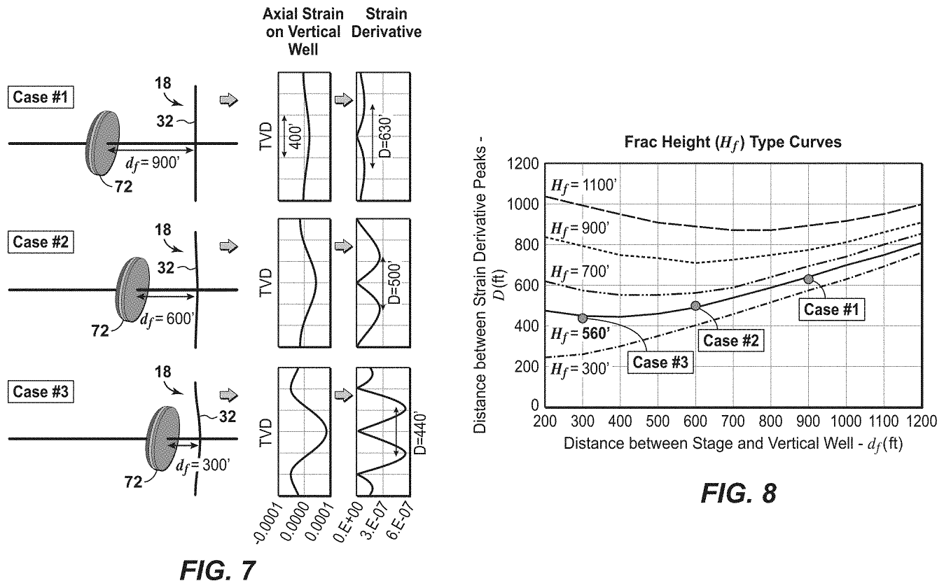

As discussed, and illustrated by Equations (1) and (2), the relative orientation and/or geometry between the fracture and the optical fiber has a quantifiable impact on the strain that is measured in the optical fiber during formation of the hydraulic fracture and/or during a change in the geometric property of the hydraulic fracture. FIGS. 7-8 illustrate the impact of distance between hydraulic fracture 72 and monitor well 18 on the strain measured within optical fiber 32. More specifically, FIG. 7 illustrates that, increasing the distance between the hydraulic fracture and the optical fiber causes the measured strain to flatten and broaden. FIG. 7 also illustrates that the measured distance between peaks in the strain derivative with respect to position along the length of the optical fiber also increases with increasing distance between the hydraulic fracture and the optical fiber.

As discussed in more detail herein, the distance between the peaks within the strain derivative may be related to the height of hydraulic fractures 72. However, as illustrated in FIG. 7, this peak-to-peak distance also varies with the distance between the hydraulic fracture and the optical fiber. In order to deconvolute these two effects and/or to obtain a measure and/or estimation of the actual height of the hydraulic fracture, Equation (1) may be utilized to generate a series of type curves that relate fracture height (Hf in FIG. 8, or 2c in FIG. 6) to the measured distance between the peaks within the strain derivative curves (D in FIG. 7) and also to the distance between the hydraulic fracture and the optical fiber (d_{f} in FIG. 7). FIG. 8 illustrates such type curves and shows that, for the conditions illustrated in FIG. 7, the combination of the three distances, d_{f}, between the fracture and the optical fiber and the three corresponding distances, D, between peaks in the strain derivative curves all lie along the type curve for a fracture height, Hf, of 560 feet. Thus, FIGS. 7-8 illustrate a mechanism via which the actual fracture height may be estimated, calculated, and/or determined based on information regarding strain within an optical fiber that is spaced-apart from the actual fracture.

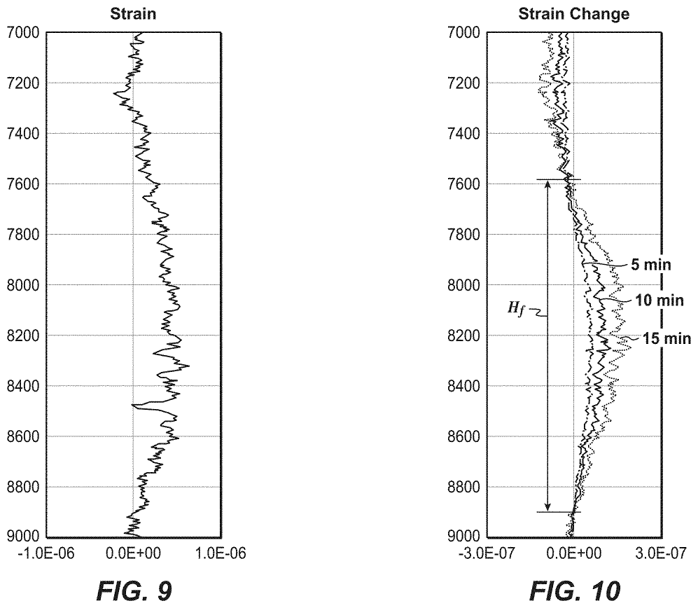

FIG. 9 is an illustration of optical fiber strain as a function of position that may be measured with a vertical monitor well and at the end of a hydraulic fracturing operation. In this case, the rock around the monitor well has been fractured, and these prior fractures have complicated the strain profiles measured by the fiber, making it difficult to obtain a reliable estimate of fracture dimensions using the strain profiled recorded at the end of a fracturing operation.

FIG. 10 illustrates changes in the measured strain at 5, 10, and 15 minutes after the hydraulic fracturing operation has ceased. FIG. 10 illustrates that the magnitude of strain within the optical fiber decreases with time, and this decrease in measured strain may be attributed to a decrease in a width of the hydraulic fracture that caused deformation of the optical fiber. FIG. 10 also illustrates that the point of 0 strain change remains at least substantially constant during the observed strain relaxation. This indicates that the location of the top and bottom ends of the hydraulic fracture remain at least substantially constant during the strain relaxation that is illustrated by FIGS. 9-10, while the thickness of the fracture gradually decreases. As such, the fracture height, Hf, may be estimated from the strain relaxation data, as indicated in FIG. 10.

As discussed herein with reference to FIG. 2, horizontal monitor wells may provide information regarding a length or a thickness of corresponding fractures. For monitor wells that extend parallel to the length of the fracture, such as for horizontal well 12C that is illustrated in FIG. 2, calculation of the length of the fracture, Lf, may be performed in a manner that is at least substantially similar to that disclosed herein to determine the height of the fracture, Hf, utilizing a vertical monitor well.

For monitor wells that extend perpendicular, or at least substantially perpendicular, to the fracture, Equation (2) may be utilized to relate strain within the horizontal fiber to the thickness of the fracture, or T_{f}, in FIG. 2. If the fiber passes through the center of the fracture, Equation (2) reduces to:

$${ɛ}_{h} = \frac{1 + v}{E} P \{ ( 1 - 2 v ) [ \frac{y}{\sqrt{{y}^{2} + {c}^{2}}} - 1 ] + \frac{{yc}^{3}}{{( {y}^{2} + {c}^{2} )}^{2}} \} \qquad ( 3 )$$

where the various parameters are defined herein with reference to Equation (2) and FIG. 6.

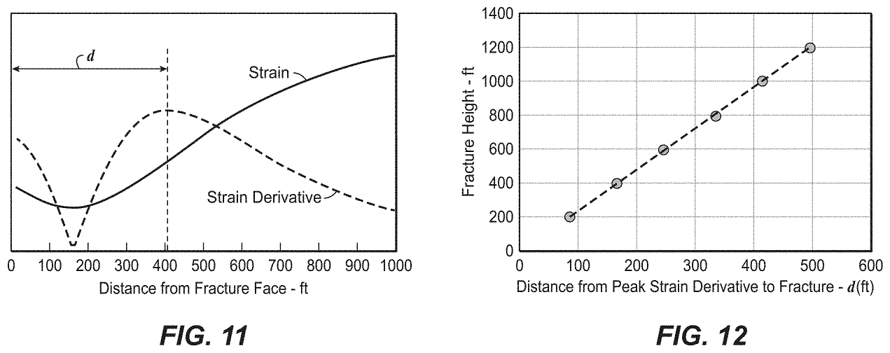

For the above-described configuration, namely, a horizontal fiber that extends nominally perpendicular and through the center of a fracture, FIG. 11 is an illustration of strain, which is caused by a change in the thickness of a fracture, as a function of distance from the fracture face and along the length of a horizontal fiber. FIG. 11 also illustrates the derivative of strain with respect to distance.

Utilizing Equation (3), a type curve that describes fracture height, Hf, as a function of distance from the fracture face to the strain derivative peak, d, in FIG. 11, may be obtained. An example of such a type curve is illustrated in FIG. 12. From the type curve, the fracture height of a fracture may be estimated from information obtained from a horizontal fiber that extends at least substantially perpendicular to, and through the center of, the fracture.

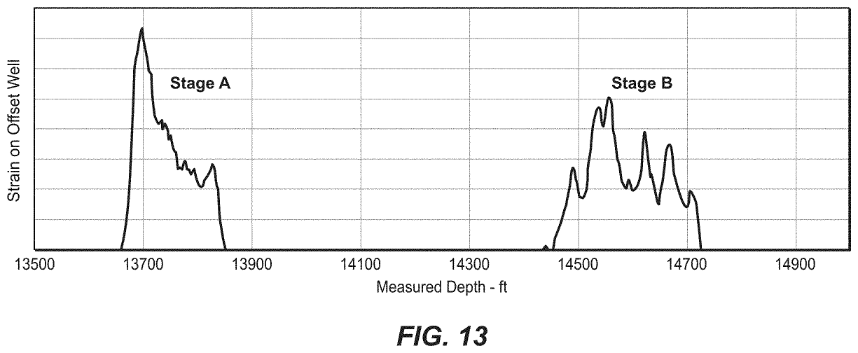

As discussed, strain experienced by a horizontal fiber that runs through a fracture may be related to the thickness of the fracture, or T_{f} in FIG. 2. With this in mind, the strain observed as a function of position for different fracture stages may be indicative of fracture-to-fracture uniformity within the subsurface region. As an example, FIG. 13 illustrates strain measured within a horizontal monitor well, such as horizontal well 12B of FIG. 2, as a function of position along the length of an optical fiber that extends within the monitor well and for two fracture stages, namely, Stage A and Stage B. As illustrated in FIG. 13, the fracturing in Stage A shows increased strain, which may be indicated of increased fracturing fluid uptake, on the leftmost side of the stage, while Stage B generally shows more uniform fluid uptake across the stage.

FIG. 14 is a flowchart depicting examples of methods 100 of monitoring a geometric property of a hydraulic fracture within a subsurface region, according to the present disclosure. Methods may be performed within and/or utilizing any suitable well that extends within a subsurface region, including any of the wells 10 that are disclosed herein.

Methods 100 may include positioning an optical fiber within a wellbore at 105 and/or initiating a change in a geometric property of a hydraulic fracture at 110. Methods 100 include repeatedly measuring fiber strain at 115 and may include curve fitting the fiber strain at 120. Methods 100 also include differentiating the fiber strain at 125 and determining the geometric property of the hydraulic fracture at 130. Methods 100 further may include estimating a parameter at 135, establishing a property of a new wellbore at 140, and/or drilling the new wellbore at 145.

In some examples of methods 100, the optical fiber may be positioned, or already may be positioned, within the wellbore. In some such examples, the optical fiber may be permanently positioned within the wellbore, such as by being cemented within the wellbore and/or within an annular space that extends between the wellbore and a downhole tubular that may be positioned within the wellbore.

Some examples of methods 100 may include positioning the optical fiber within the wellbore at 105. The positioning at 105 may include positioning the optical fiber within the wellbore in any suitable manner. As examples, the positioning at 105 may include positioning the optical fiber within a tubular conduit of the downhole tubular and/or within the annular space. As another example, the positioning at 105 may include permanently positioning the optical fiber within the wellbore. As yet another example, the positioning at 105 may include temporarily positioning the optical fiber within the wellbore.

In a more specific example, the optical fiber may at least partially define a downhole assembly that may be temporarily and/or permanently positioned within the wellbore. Examples of the downhole assembly include an intervention cable that may be pumped into the wellbore, coiled tubing that may be extended into the wellbore, and/or a flexible rod that may be extended into the wellbore. When methods 100 include the positioning at 105, the positioning at 105 further may include coupling the optical fiber to the wellbore and/or to the downhole tubular, such as to improve and/or increase a measurement accuracy of the measuring at 115.

The positioning at 105 may be performed with any suitable timing and/or sequence during methods 100. As examples, the positioning at 105 may be performed prior to the initiating at 110 and/or prior to the measuring at 115.

Initiating the change in the geometric property of the hydraulic fracture at 110 may include commencing, starting, and/or providing a motive force for the change in the geometric property of the hydraulic fracture. In some examples, the initiating at 110 may include forming, defining, and/or expanding the hydraulic fracture. In some examples, the initiating at 110 may include pressurizing the subsurface region, pressurizing the hydraulic fracture with a pressurizing fluid, depressurizing the subsurface region, depressurizing the hydraulic fracture, and/or performing a hydraulic fracturing operation within the subsurface region. The geometric property of the hydraulic fracture may include changing a length of the fracture, a height of the fracture, and/or a thickness of the fracture.

Repeatedly measuring fiber strain at 115 may include repeatedly measuring the fiber strain during and/or as caused by a change in the geometric property of the hydraulic fracture. As an example, the change in the geometric property of the hydraulic fracture may cause deformation of strata that extends within the subsurface region. This deformation of strata may cause, produce, and/or generate deformation, or strain, within the optical fiber, which may be referred to herein as fiber strain.

The repeatedly measuring at 115 may include repeatedly measuring the fiber strain with the optical fiber, repeatedly measuring the fiber strain as a function of position along a length of the optical fiber, and/or repeatedly measuring the fiber strain at a plurality of measurement times. Examples of the hydraulic fracture, the optical fiber, and the wellbore are disclosed herein with reference to hydraulic fracture 72, optical fiber 32, and/or wellbore 20, respectively, of FIGS. 1-2.

The repeatedly measuring at 115 may be accomplished in any suitable manner. As an example, the repeatedly measuring at 115 may include optically measuring the fiber strain. As discussed herein with reference to FIG. 1, the optically measuring may include providing an optical signal to an initiation location of the optical fiber, conveying the optical signal away from the initiation location along a length of the optical fiber, and/or scattering a respective scattered fraction of the optical signal at a respective one of a plurality of distributed sensing location spaced apart along the length of the optical fiber. The optically measuring additionally or alternatively may include conveying the respective scattered fraction of the optical signal toward the initiation location and/or along the length of the optical fiber. The optically measuring further may include detecting the respective scattered fraction of the optical signal at a detection location of the optical fiber.

The providing the optical signal may include providing with, via, and/or utilizing any suitable optical signal generator, such as optical signal generator 92 of FIG. 1. The providing the optical signal also may include providing the optical signal at any suitable optical signal frequency. Examples of the optical signal frequency include frequencies of at least 1 Hertz (Hz), at least 2 Hz, at least 4 Hz, at least 6 Hz, at least 8 Hz, at least 10 Hz, at least 15 Hz, at least 20 Hz, at least 30 Hz, at most 1,000 Hz, at most 900 Hz, at most 800 Hz, at most 700 Hz, at most 600 Hz, at most 500 Hz, at most 400 Hz, at most 300 Hz, at most 200 Hz, at most 100 Hz, at most 75 Hz, at most 50 Hz, at most 40 Hz, and/or at most 30 Hz.

The plurality of distributed sensing locations may include any suitable location, within the optical fiber, that at least partially scatters the optical signal, such as distributed sensing locations 36 of FIG. 1. In some examples, an uphole, or a terminal, end of the optical fiber may define both the initiation location and the detection location.

The optically measuring may include determining and/or quantifying any suitable property of the optical signal and/or of the respective scattered fraction of the optical signal. As an example, the optically measuring may include detecting a change in at least one optical property between the optical signal and the respective scattered fraction of the optical signal. Examples of the change in at least one optical property include a phase shift, a frequency shift, and/or an amplitude change between the optical signal and the respective scattered fraction of the optical signal.

In some examples of methods 100, the optically measuring further may include correlating the change in at least one optical property with and/or to a strain rate within the optical fiber. In a specific example, the optically measuring may include optically measuring strain rate as a function of position along the length of the optical fiber. In some such examples, each instance of the repeatedly measuring at 115 further may include integrating, with respect to time, the strain rate as the function of position along the length of the optical fiber, at each position, to generate the fiber strain during each instance of the repeatedly measuring.

Curve fitting the fiber strain at 120 may include curve fitting the fiber strain as a function of position to generate a fiber strain as a function of position curve fit. State another way, the repeatedly measuring at 115 may generate fiber strain data, or data that may be related to fiber strain, at a plurality of discrete locations along the length of the optical fiber, and the curve fitting at 120 may include curve fitting the fiber strain data to produce and/or to generate the fiber strain as the function of position curve fit. When methods 100 include the curve fitting at 120, the curve fitting at 120 may be performed subsequent to the repeatedly measuring at 115, subsequent to at least one instance of the repeatedly measuring at 115, and/or prior to the differentiating at 125. Additionally or alternatively, and when methods 100 include the curve fitting at 120, the differentiating at 125 may include differentiating the fiber strain as the function of position curve fit.

Differentiating the fiber strain at 125 may include differentiating the fiber strain as the function of position to determine a strain differential as a function of position along the length of the optical fiber. The differentiating at 125 additionally or alternatively may include differentiating the fiber strain as the function of position for, or at, a given measurement time of the plurality of measurement times, such as to produce and/or to generate the strain differential as the function of position along the length of the optical fiber at the given measurement time. The strain differential may include and/or be the derivative of fiber strain with respect to position along the length of the optical fiber.

In some examples, the differentiating at 125 may include numerically and/or discretely differentiating the fiber strain as the function of position. In some examples, such as when methods 100 include the curve fitting at 120, the differentiating at 125 may include differentiating the fiber strain as the function of position curve fit.

Determining the geometric property of the hydraulic fracture at 130 may include calculating, estimating, approximating, and/or measuring any suitable geometric property of the hydraulic fracture based, at least in part, on the strain differential as a function of positon along the length of the optical fiber.

In some examples, and as discussed in more detail herein with reference to FIG. 2, the well may extend parallel to a fracture plane of the fracture, may extend at least substantially parallel to the fracture plane of the fracture, and/or may extend along a major axis of the fracture, such as along a fracture height of the fracture and/or along a fracture length of the fracture. This may include wells that extend vertically, such as vertical wells 14A and 14B in FIG. 2, and/or wells that extend horizontally, such as horizontal well 12C of FIG. 2.

As discussed in more detail herein, a similar analysis applies, with the obtained result (fracture height or fracture length) being dictated by the orientation of the wellbore that is utilized, during the measuring at 115, to measure the fiber strain. With this in mind, the following discussions will refer to calculation of the geometric property of the hydraulic fracture in the form of a major dimension of the hydraulic fracture, with this major dimension of the hydraulic fracture being either the fracture height or the fracture length, depending on the well orientation.

In such well configurations, the strain differential as the function of position along the length of the optical fiber, which is generated during the differentiating at 125, may include a first strain differential peak at a first peak position along the length of the optical fiber and a second strain differential peak at a second position along the length of the optical fiber, as perhaps best illustrated in FIGS. 5 and 7. The first peak position may correspond to a first edge, a first edge region, and/or a first boundary of the hydraulic fracture, and the second position may correspond to a second edge, a second edge region, and/or second boundary of the hydraulic fracture. The second edge may be opposed to the first edge, such as may be established along a line that runs parallel to the well.

When the wellbore that includes the optical fiber includes a vertical wellbore region and the fiber strain as the function of position is measured within the vertical wellbore region, the first position may correspond to a top edge of the hydraulic fracture, while the second position may correspond to an opposed bottom edge of the hydraulic fracture, with the fracture height being measured between the top edge and the bottom edge. When the wellbore that includes the optical fiber includes a horizontal wellbore region and the fiber strain as the function of position is measured within the horizontal wellbore region, the first position may correspond to a first side of the hydraulic fracture and the second position may corresponding to an opposed second side of the hydraulic fracture, with the fracture length being measured between the first side and the second side.

In such configurations, the determining at 130 may include determining the major dimension of the hydraulic fracture based, at least in part, on a difference between the first position and the second position. The major dimension of the hydraulic fracture may include the fracture height of the hydraulic fracture when the well that includes the optical fiber extends vertically and along the fracture height of the hydraulic fracture. Additionally or alternatively, the major dimension of the hydraulic fracture may include the fracture length of the hydraulic fracture when the well that includes the optical fiber extends horizontally and along the length of the hydraulic fracture.

As also discussed herein with reference to FIG. 2, the hydraulic fracture may extend from the wellbore that includes the optical fiber. Stated another way, the same wellbore may be utilized both to form the hydraulic fracture and to monitor the geometric property of the hydraulic fracture. Such a configuration is illustrated, for example, by horizontal well 12A and/or by vertical well 14B of FIG. 2.

Additionally or alternatively, and as also discussed herein with reference to FIG. 2, the wellbore that includes the optical fiber may include and/or be a monitor wellbore, and the hydraulic fracture may extend from a fracture wellbore, or a treatment well, that is spaced apart from the monitor wellbore. Such a configuration is illustrated, for example, by horizontal well 12C and/or by vertical well 14A of FIG. 2.

A benefit of such a configuration may be a reduction in measurement noise, which may be caused by flow of fluid within the fracture wellbore during the change in the geometric property of the hydraulic fracture. However, in such a configuration, the monitor wellbore may be positioned close enough to the fracture wellbore that deformation, within the subsurface region and due to changes in the geometric property of the hydraulic fracture, causes strain within the optical fiber even though the optical fiber does not extend directly within the fracture.

In some such examples, the determining at 130 further may include determining the major dimension of the hydraulic fracture may be based, at least in part, on a distance between the monitor wellbore and the hydraulic fracture. An appropriate analysis, which may be utilized to determine the major dimension of the hydraulic fracture based both upon the strain differential as the function of position along the length of the optical fiber and on the distance between the monitor wellbore and the hydraulic fracture, is discussed herein with reference to FIGS. 6-8. As an example, the type curves illustrated in FIG. 8 may be utilized to adjust, or to scale, the distance between the first position and the second position based upon the distance between the fracture and the monitor well to provide an improved, or a more accurate, determination of the major dimension of the hydraulic fracture.

In some examples, and as discussed in more detail herein with reference to FIG. 2, the well may extend perpendicular to the hydraulic fracture, may extend at least substantially perpendicular to the hydraulic fracture, may extend along a minor axis of the hydraulic fracture, and/or may extend across a thickness of the hydraulic fracture. This may include wells that extend horizontally, such as horizontal wells 12A and 12B of FIG. 2.

In such well configurations, the strain differential as the function of position along the length of the optical fiber may include a strain differential peak at a strain differential peak position that may be spaced apart from a fracture face position of a fracture face of the hydraulic fracture. An example of this is illustrated in FIG. 11. Also in such well configurations, the determining at 130 may include determining the geometric property of the hydraulic fracture, in the form of the fracture height of the hydraulic fracture, based, at least in part, on a difference between the strain differential peak position and the fracture face position. Stated another way, the strain differential peak position, or the difference between the strain differential peak position and the fracture face position, may correspond to the fracture height of the hydraulic fracture.

In some examples, the wellbore may include and/or be both a treatment wellbore and a monitor wellbore. Stated another way, and in these examples, the hydraulic fracture may extend from the wellbore that includes the optical fiber. In some examples, the wellbore is a monitor wellbore and the hydraulic fracture extends from a fracture wellbore that is spaced-apart from the monitor wellbore. In both examples, a strain derivative curve, as illustrated in FIG. 11, may be utilized to determine a distance, d, between the fracture face and the strain derivative peak position. A type curve, such as the type curve illustrated in FIG. 12, then may be utilized to estimate the fracture height based upon the distance, d. As discussed in more detail herein, the type curve of FIG. 12 may be generated utilizing Equation (3). Stated another way, fracture height, as determined from the type curve of FIG. 12, may be determined based upon the well configuration and also on one or more material properties of the subsurface region, namely, the Young's Modulus and/or Poisson's Ratio of the subsurface region.

Estimating the parameter at 135 may include estimating any suitable parameter and/or parameters of the well and/or of the subsurface region. The parameter and/or parameters may be based, at least in part, on the fiber strain as the function of position along the length of the optical fiber, the strain differential as the function of position along the length of the optical fiber, changes in the fiber strain with time, changes in the strain differential with time, one or more material properties of the subsurface region, and/or the well geometry. Examples of the parameter and/or parameters are disclosed herein.

In some examples, the estimating at 135 may include estimating a strain proportionality constant. The strain proportionality constant may correlate strain experienced by the subsurface region during a change in a geometric property of a fracture to fiber strain as the function of position that is measured along the length of the optical fiber.

As an example, a vertical strain proportionality constant may be estimated to correlate vertical strain experienced by the subsurface region to vertical fiber strain according to Equation (4):

εᵥᵣ=αᵥε_{vf} (4)

where εᵥᵣ is the vertical strain experienced by the subsurface region, αᵥ is the vertical strain proportionality constant, and ε_{vf} is the vertical fiber strain measured within a vertical optical fiber.

Similarly, a horizontal strain proportionality constant may be estimated to correlate horizontal strain experienced by the subsurface region to horizontal fiber strain according to Equation (5):

εₕᵣ=αₕε_{hf} (5)

where εₕᵣ is the horizontal strain experienced by the subsurface region, αₕ is the horizontal strain proportionality constant, and ε_{hf} is the horizontal fiber strain measured within a horizontal optical fiber.

This analysis may include determining the fracture height, Hf, such as discussed herein with respect to the determining at 130. This may include determining the fracture height for a vertical monitor well and/or for a horizontal monitor well, as appropriate and depending upon the geometry of the well that includes the optical fiber and/or that is utilized to determine fiber strain as the function of position along the length of the optical fiber.

The estimating the strain proportionality constant then may include modeling the fracture, or selecting a model for the fracture, utilizing relevant material properties for the subsurface region. The estimating the strain proportionality constant then may include determining, from the model, vertical strain along the vertical monitor well or horizontal strain along the horizontal monitor well and subsequently comparing the determined strain profile with the fiber strain as the function of position that is measured along the length of the optical fiber. The estimating the strain proportionality constant further may include selecting the strain proportionality constant to provide a correspondence between the vertical strain determined from the model and the fiber strain as the function of position that is measured along the length of the optical fiber.

In some examples, the estimating at 135 may include estimating a fracture uniformity of a plurality of fractures that extends within the subsurface region. The fracture uniformity may be estimated based, at least in part, on the fiber strain as the function of position along the length of the optical fiber. More specifically, and as discussed in more detail herein with reference to FIG. 13, the fiber strain as the function of position along the length of the optical fiber may be measured for the plurality of fractures. The fiber strain then may be viewed and/or analyzed to qualitatively and/or quantitatively estimate fracture uniformity.

As an example, and with reference to FIG. 13, it may be qualitatively observed that Stage A is less uniform than Stage B. More specifically, Stage A exhibited a large peak in fiber strain toward the uphole side of the fracture when compared to a remainder of the fracture, while Stage B exhibited a more uniform fiber strain thereacross.

As another example, one or more statistical analyses may be utilized to more quantitatively estimate fracture uniformity. As an example, a standard deviation, a minimum, a maximum, a range, and/or various percentiles may be utilized to more quantitatively compare fiber strain observed during formation of Stage A to fiber strain observed during formation of Stage B.

In some examples of methods 100, and as discussed in more detail herein with reference to the initiating at 110, the methods may include pressurizing the hydraulic fracture with a pressurizing fluid. This may include supplying the pressurizing fluid, or a volume of the pressurizing fluid, to the subsurface region and/or to the fracture, such as to form the fracture and/or to increase a size of the fracture. This also may include ceasing the supplying the pressurizing fluid subsequent to pressurization of the hydraulic fracture.

In some such examples, methods 100 further may include repeatedly performing at least the measuring at 115, the differentiating at 125, and/or the determining at 130 a plurality of distinct times subsequent to the pressurizing and/or subsequent to the ceasing the pressurizing, such as to determine fiber strain as a function of position and/or to determine the geometric property of the hydraulic fracture at the plurality of distinct times subsequent to the pressurizing and/or subsequent to the depressurizing. FIG. 9 illustrates fiber strain that may be observed as a result of the pressurizing, and FIG. 10 illustrates a change in fiber strain that may be observed at 5, 10, and 15 minutes after ceasing the pressurizing.

In some examples, the estimating at 135 may include estimating a leak-off rate of the pressurizing fluid into the subsurface region. The leak-off rate may be estimated based, at least in part, on the volume of the pressurizing fluid that was provided to the fracture and/or the kinetic information obtained from the fiber strain as the function of position at the plurality of distinct times subsequent to pressurizing the hydraulic fracture (e.g., as illustrated in FIG. 10).

As an example, the strain relaxation that is illustrated in FIG. 10 may be utilized to estimate a change in fracture volume of the hydraulic fracture with time subsequent to the pressurizing. Under conditions in which the change in fracture volume with time is caused by leak-off of the pressurizing fluid into the subsurface region, the leak-off rate of the pressurizing fluid into the subsurface region then may be estimated from the change in fracture volume with time.

In some examples, the estimating at 135 may include estimating a fracture volume of the hydraulic fracture. The fracture volume of the hydraulic fracture may be estimated based, at least in part, on the geometric property of the hydraulic fracture, the volume of the pressurizing fluid, and/or the leak-off rate.

As an example, the fracture volume immediately subsequent to the pressurizing may be estimated, such as from the volume of the pressurizing fluid that is provided to the fracture. As another example, the estimated fracture volume may be adjusted based upon the leak-off rate of the pressurizing fluid into the subsurface region.

In some examples, the estimating at 135 may include correlating a fracture relaxation rate to the fiber strain as a function of position at the plurality of distinct times subsequent to the pressurizing. As an example, the fracture relaxation rate may be estimated and/or inferred from the strain change data that is illustrated in FIG. 10.

Establishing the property of the new wellbore at 140 may include determining and/or selecting any suitable property of the new wellbore. The establishing at 140 may be performed subsequent to the determining at 130 and/or based, at least in part, on the geometric property of the hydraulic fracture. As an example, the establishing at 140 may be utilized to improve and/or to optimize well placement and/or well configurations for a plurality of wells that extend within a given reservoir that extends within the subsurface region. This may increase overall production from the given reservoir and/or decrease a potential for hydraulic communication between adjacent wells that extend within the given reservoir.

As a more specific example, knowledge of fracture height, fracture length, and/or fracture volume may be utilized to estimate a subset of the given reservoir that may be drained, or effectively drained, by a given wellbore. Based upon this information and/or upon estimates regarding the fracture height, fracture length, and/or fracture volume of yet-to-be-formed fractures, the property of the new wellbore may be established. Examples of property of the new wellbore include a location of the new wellbore, a distance between the new wellbore and the wellbore, a landing depth for the new wellbore, and/or a distance between the new wellbore and a specific subsurface feature.

Drilling the new wellbore at 145 may include drilling the new wellbore within the subsurface region. The drilling at 145 additionally or alternatively may include regulating at least one aspect of the drilling of the new wellbore based, at least in part, on the establishing at 140. Stated another way, the drilling at 145 may include drilling such that the new wellbore exhibits the property established during the establishing at 140.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

### INDUSTRIAL APPLICABILITY

The systems and methods disclosed herein are applicable to the well drilling and completion industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A method of monitoring a geometric property of a hydraulic fracture within a subsurface region, the method comprising:
during a change in the geometric property of the hydraulic fracture, repeatedly measuring fiber strain as a function of position along a length of an optical fiber that is positioned within a wellbore that extends within the subsurface region, wherein the repeatedly measuring includes repeatedly measuring at a plurality of measurement times;
for a given measurement time of the plurality of measurement times, differentiating the fiber strain as the function of position to determine a strain differential as a function of position along the length of the optical fiber; and
determining the geometric property of the hydraulic fracture based, at least in part, on the strain differential as the function of position along the length of the optical fiber.

2. The method of claim 1, wherein the wellbore at least one of:
(i) extends parallel to a fracture plane of the hydraulic fracture;
(ii) extends at least substantially parallel to a fracture plane of the hydraulic fracture;
(iii) extends along a length of the hydraulic fracture; and
(iv) extends along a major axis of the hydraulic fracture.

3. The method of claim 1, wherein the strain differential as the function of position along the length of the optical fiber includes a first strain differential peak at a first position along the length of the optical fiber and a second strain differential peak at a second position along the length of the optical fiber, and further wherein the determining the geometric property of the hydraulic fracture includes determining a fracture height of the hydraulic fracture based, at least in part, on a difference between the first position and the second position.

4. The method of claim 3, wherein the first position corresponds to a first edge of the hydraulic fracture, and further wherein the second position corresponds to a second edge of the hydraulic fracture.

5. The method of claim 3, wherein the wellbore includes a vertical wellbore region, wherein the fiber strain as the function of position is measured within the vertical wellbore region, wherein the first position corresponds to a top edge of the hydraulic fracture, and further wherein the second position corresponds to a bottom edge of the hydraulic fracture.

6. The method of claim 3, wherein the wellbore includes a horizontal wellbore region, wherein the fiber strain as the function of position is measured within the horizontal wellbore region, wherein the first position corresponds to a first side of the hydraulic fracture, and further wherein the second position corresponds to an opposed second side of the hydraulic fracture.

7. The method of claim 3, wherein the hydraulic fracture extends from the wellbore.

8. The method of claim 3, wherein the wellbore is a monitor wellbore and the hydraulic fracture extends from a fracture wellbore that is spaced apart from the monitor wellbore.

9. The method of claim 8, wherein the fracture height of the hydraulic fracture further is based, at least in part, on a distance between the monitor wellbore and the hydraulic fracture.

10. The method of claim 1, wherein the wellbore at least one of:
(i) extends perpendicular to the hydraulic fracture;
(ii) extends at least substantially perpendicular to the hydraulic fracture;
(iii) extends along a minor axis of the hydraulic fracture; and
(iv) extends across a thickness of the hydraulic fracture.

11. The method of claim 1, wherein the strain differential as the function of position along the length of the optical fiber includes a strain differential peak at a strain differential peak position that is spaced-apart from a fracture face position of a fracture face of the hydraulic fracture, and further wherein the determining the geometric property of the hydraulic fracture includes determining a fracture height of the hydraulic fracture based, at least in part, on a difference between the strain differential peak position and the fracture face position.

12. The method of claim 11, wherein the wellbore is a horizontal wellbore, and further wherein the strain differential peak position corresponds to the fracture height of the hydraulic fracture.

13. The method of claim 11, wherein the hydraulic fracture extends from the wellbore.

14. The method of claim 11, wherein the wellbore is a monitor wellbore and the hydraulic fracture extends from a fracture wellbore that is spaced-apart from the monitor wellbore.

15. The method of claim 14, wherein the fracture height of the hydraulic fracture further is based, at least in part, on a material property of the subsurface region.

16. The method of claim 1, wherein the method further includes initiating the change in the geometric property of the hydraulic fracture.

17. The method of claim 16, wherein the initiating the change includes at least one of:
(i) pressurizing the subsurface region;
(ii) depressurizing the subsurface region; and
(iii) performing a hydraulic fracturing operation within the subsurface region.

18. The method of claim 1, wherein the measuring the fiber strain includes optically measuring the fiber strain.

19. The method of claim 18, wherein the optically measuring includes:
(i) providing an optical signal to an initiation location of the optical fiber;
(ii) conveying the optical signal away from the initiation location along a length of the optical fiber;
(iii) scattering a respective scattered fraction of the optical signal at a respective one of a plurality of distributed sensing locations spaced apart along the length of the optical fiber;
(iv) conveying the respective scattered fraction of the optical signal toward the initiation location along the length of the optical fiber; and
(v) detecting the respective scattered fraction of the optical signal at a detection location of the optical fiber.

20. The method of claim 19, wherein a terminal end of the optical fiber defines both the initiation location and the detection location.

21. The method of claim 20, wherein the optically measuring includes detecting a change in at least one optical property between the optical signal and the respective scattered fraction of the optical signal.

22. The method of claim 21, wherein the change in at least one optical property includes at least one of:
(i) a phase shift between the optical signal and the respective scattered fraction of the optical signal;
(ii) a frequency shift between the optical signal and the respective scattered fraction of the optical signal; and
(iii) an amplitude change between the optical signal and the respective scattered fraction of the optical signal.

23. The method of claim 21, wherein the optically measuring further includes correlating the change in at least one optical property to a strain rate within the optical fiber.

24. The method of claim 19, wherein the providing the optical signal includes providing the optical signal at a signal frequency of less than 20 Hertz.

25. A well, comprising:
a wellbore that extends within a subsurface region;
an optical fiber extending within the wellbore; and
a controller programmed to monitor a geometric property of a hydraulic fracture within the subsurface region by performing the method of claim 1.
